(19) United States
(12) Patent Application Publication
(10) Pub. No.: US 2009/0318308 A1
(43) Pub. Date: Dec. 24, 2009

(54) HIGHLY DIVERSIFIED ANTIBODY LIBRARIES

(75) Inventors: Philippe Mondon, Donnevile (FR); Khalil Bouayadi, Ramonville Saint-Agne (FR); Abdelhakim Kharrat, Montgiscard (FR)

Correspondence Address: YOUNG & THOMPSON, 209 Madison Street, Suite 500, Alexandria, VA, 22314, US

(73) Assignee: MILLEGEN, Labege Cedex (FR)

(21) Appl. No.: 12/302,918

(22) PCT Filed: May 30, 2006
(86) PCT No.: PCT/EP2006/006339

§ 371 Date: Dec. 1, 2008

(51) Int. Cl. C40B 40/06; C40B 50/00; C40B 50/06

(52) U.S. Cl. 506/16; 506/23; 506/26

(57) ABSTRACT

The present invention provides an in vitro method for obtaining a library of polynucleotides encoding antibodies, derivatives thereof or fragments thereof, comprising the step of performing random mutagenesis of a polynucleotide encoding the variable region of a heavy chain and/or the variable region of a light chain of a light chain, wherein random mutagenesis is performed on a library of polynucleotides comprising a sequence encoding the variable region of a heavy chain and/or the variable region of a light chain; and wherein the random mutagenesis process creates randomly distributed mutations along at least 70% of the sequence encoding the variable region.

### FIELD OF THE INVENTION

This invention relates to highly diversified antibody libraries and methods for generating highly diversified antibody libraries.

### BACKGROUND OF THE INVENTION

Human antibody fragments can be directly selected from antibody gene repertoires expressed on the surface of filamentous bacteriophages (Winter et al 1994 Annu Rev Immunol 12:433-455), of yeast cells (Feldaus et al 2003 Nat Biotechnol 21:163-170), of bacterial cells or of ribosomes (Hanes J. and Pluckthun A. 1997 PNAS 94:4937-42).

The use of large and diverse human antibodies libraries provide several advantages: Animal immunization can be bypassed. Antibodies may be generated against antigens which are toxic upon immunization or have a low immunogenicity. Furthermore, in contrast to murine monoclonal antibodies, the use of human antibodies diminishes the risk of allergic response.

The diversity of the library determines the probability to isolate an antibody with high affinity for a given antigen.

Antibodies libraries may be obtained from natural sources. Diverse libraries of immunoglobulin heavy (VH) and light (VL: V kappa and V lambda) chain variable (V) genes were prepared from B-cells of unimmunized donors (Marks et al 1991 J Mol Biol 222:581-597) or of immunized donors (Barbas et al, 1991 PNAS 88:7978-7982; Clackson et al 1991 Nature 352:624-628) by polymerase chain reaction (PCR) amplification. Genes encoding single chain antibody (scFv) were made by randomly combining heavy and light chain V-genes using PCR, and the combinatorial library was cloned for display on the surface of a phage.

Alternatively libraries may be obtained through the artificial introduction of mutations into the complementarity determining regions (CDR) of the heavy chains or of the light chain domains.

The CDRH3 loop of the variable heavy genes varies in size and sequence during the rearrangement of the V-D-J segments in the process of forming the unmutated VH repertoire and plays a dominant role in the antibody diversity. CDRH3 is located at the center of the antigen binding site and it is the most variable among the CDRs in natural antibody. Synthetic libraries were constructed by the randomization with degenerate primers of the CDRH3. Several studies showed that medium size libraries (5×10⁷ members) with variation in the CRDH3 have provided a successful selection of novel antibody specificities (Barbas et al 1992 PNAS 89:4457-4461; Hoogenboom and Winter 1992 J Mol Biol 227:381-388). Larger libraries >10⁸ members with CDRH3 sequence lengths of 4-21 residues from 50 VH (Nissim et al 1994 EMBO 13:692-698) and 6-15 residues in 49 different VH genes (de Kruif et al 1995 J Mol Biol 248:97-105) allowed the selection of antibody fragments with different specificities. The third CDR strongly contributes to the overall specificity of an antibody. However the drawback of this approach is to shadow the remaining five CDR-loops which also contribute to the specificity and affinity of the antibody.

Another approach combines all the CDR using a CDR-Implantation Technology (cf. WO0175091). The degree of functional variation is achieved by means of simultaneous and random combination of six biologically derived CDRs (Soderlind et al 2000 Nature 18:852-856). The CDRs from a cDNA library prepared from peripheral blood B cell were combined within a selected framework of the DP-47 germline gene (VH3 family) by overlap extension PCR. The genetic diversity produced with this process is different from naturally created in the immune system. This means that this new type of antibody could be potentially immunogen.

Furthermore, the library is based on a single framework and this hinders the ability of the antibodies of the library to bind all types of antigens.

Another approach is disclosed in U.S. Pat. No. 6,828,422 and in Knappik et al 2000 J mol Biol 296:57-86. Each of the human VH and VL subfamilies that is frequently used during an immune response was represented by one consensus framework, resulting in seven master genes for VH and seven master genes for VL to obtain 49 combinations. Diversity was created by replacing the VH and VL CDR3 regions of the master genes by CDR3 library cassettes, generated from mixed trinucleotides and biased towards natural human antibody CDR3 sequences. The sequencing of 257 members of the unselected libraries indicated that the frequency of correct and thus potentially functional sequences was 61%. However, the limited variability found in key residues in the CDR encoded by the few VH and VL used limits its ability to recognize certain target antigens. Structural incompatibility between these foreign CDRs and the fixed framework may potentially prevent the formation of functional antibody.

Various in vitro strategies were used to optimize an antibody selected from a library screening. These include site specific mutagenesis based on structural information or combinatorial mutagenesis of CDR. Mutations are usually restricted to the antigen binding surface (CDR). However, although the framework regions of the variable domains VH and VL are not directly in contact with the antigen, framework residues can have indirect effects on binding by affecting the CDR conformation. It was demonstrated that the affinity optimization could be obtained through association of mutations in the CDR and also in the framework variable fragments (Schier et al 1996 J Mol Biol 255:28-43, Boder et al 2000 PNAS 97:10701-10705, Hanes et al 2000 Nature 18:1287-1292, Irving et al 2001 J Immunol Methods 248:31-45). In the humanization process of the antibodies, simple grafting of the CDR sequences often yields humanized antibodies that bind the antigen much more weakly than the parent murine antibody. The affinity of an antibody is optimized by replacing key residues in the framework regions (cf. Baca et al 1997, J Biol Chem 272:10678-10684 and EP1325932). However, optimization of the framework residues is time consuming and tedious.

There remains a general need in the art for antibody libraries with an increased diversity which will enable the rapid selection and production of antibodies, derivatives thereof or fragments thereof, which bind to a bait molecule with a high affinity.

### SUMMARY OF THE INVENTION

The present invention provides an in vitro method for obtaining a library of polynucleotides encoding antibodies, derivatives thereof or fragments thereof, comprising the step of performing random mutagenesis of a polynucleotide encoding the variable region of a heavy chain and/or the variable region of a light chain, wherein random mutagenesis is performed on a library of polynucleotides comprising a sequence encoding the variable region of a heavy chain and/or the variable region of a light chain; and wherein the random mutagenesis process creates randomly distributed mutations along at least 70% of the sequence encoding the variable region.

By creating randomly distributed mutations along at least 70% of the sequence encoding the variable region, mutations within the CDRs and within the framework are created. By performing this random mutagenesis process on a library of polynucleotides comprising a sequence encoding the variable region, a highly diversified library of polynucleotides with mutations within the CDRs and/or within the framework is generated. This library with increased diversity enables the rapid selection and production of antibodies, derivatives thereof or fragments thereof, which bind to a bait molecule with a high affinity. With this library, the time consuming and tedious optimization of the framework residues is not necessary any more.

### DETAILED DESCRIPTION OF THE INVENTION

The present invention provides an in vitro method for obtaining a library of polynucleotides encoding antibodies, derivatives thereof or fragments thereof, comprising the step of performing random mutagenesis of a polynucleotide encoding the variable region of a heavy chain and/or the variable region of a light chain, wherein random mutagenesis is performed on a library of polynucleotides comprising a sequence encoding the variable region of a heavy chain and/or the variable region of a light chain; and

wherein the random mutagenesis process creates randomly distributed mutations along at least 70% of the sequence encoding the variable region.

By library of polynucleotides it is meant a large collection (i.e. >10⁴ members) of diverse polynucleotides available for screening in order to isolate interesting members.

The terms “antibodies, derivatives thereof or fragments thereof” are used in the broadest sense and specifically cover immunoglobulins, such as IgG, IgA, IgM, IgE, IgD, immunoglobulins with polyepitopic specificity, antibody fragments (e.g. the variable region of a heavy chain, the variable region of a light chain, Fab, Fab′, F(ab′)₂, Fv, as well as antibody derivatives (e.g. single chain antibody (scFv)), so long they encompass the variable region of a heavy chain or the variable region of a light chain.

Typically, the random mutagenesis process creates randomly distributed mutations along at least 75%, 80%, 90% or 95% of the sequence encoding the variable region. With this process a library of polynucleotides comprising a sequence with one or more mutations within the CDRs encoding region and/or with one or more mutations within the framework encoding regions is created. In a preferred embodiment, random mutagenesis process creates randomly distributed mutations along the whole sequence encoding the variable region.

Typically, a method according to the invention may comprise the step of performing random mutagenesis of a polynucleotide encoding the variable region of a heavy chain and the step of performing random mutagenesis of a polynucleotide encoding the variable region of a light chain.

In a preferred embodiment of the invention, the polynucleotide encoding the variable region is a polynucleotide encoding a single chain antibody.

The single chain antibody technology is well known in the art, this technology has been described in EP0281604, EP0318554 and EP0573551 for example.

In a preferred embodiment of the invention, the library of polynucleotides comprising a sequence encoding the variable region of a heavy chain and/or the variable region of a light chain, is obtainable from B-cells isolated from donors selected from the group consisting of healthy donors and donors afflicted with a disease. The B-cells may be obtained from diverse lymphoid sources including peripheral blood lymphocytes (PBLs), bone marrow, spleen or tonsil. Typically the library may be obtained from at least 50 donors. The donors may all be healthy or afflicted with a disease. Alternatively, part of donors may be healthy. Afflicted donors may suffer from bacterial infections, viral infections, autoimmune diseases, endocrine diseases (e.g. diabetes) and/or cancer.

It falls within the ability of the skilled person to choose the method for performing random mutagenesis and the suitable working conditions, which will enable the creation of randomly distributed mutations along at least 70% of the sequence encoding the variable region. Typically the skilled person may use error prone PCR. Alternatively, the skilled person may use the method disclosed in WO0238756 wherein random mutagenesis is performed by using one or more mutases selected from the group consisting of DNA polymerases beta, iota, eta and kappa.

Typically the sequence encoding the variable region of a heavy chain and/or the variable region of a light chain may be from any origins. Typically they may originate from primates, mice or camels. In a preferred embodiment the sequence encoding the variable region of a heavy chain and/or the variable region of a light chain is from human origin.

Typically the library of polynucleotides encoding antibodies, derivatives thereof or fragments thereof is a library of polynucleotides encoding derivatives or fragments selected from the group consisting of the variable region of a heavy chain, the variable region of a light chain, Fv, a single chain antibody, Fab, Fab′ and F(ab′)₂. Typically the polynucleotides encoding antibodies, derivatives thereof or fragments thereof are expression vectors.

“Expression vector” refers to polynucleotide sequences containing a desired coding sequence and control sequences in operable linkage, so that hosts transformed with these sequences are capable of producing the encoded proteins.

An embodiment of the present invention provides a library of polynucleotide encoding antibodies, derivatives thereof or fragments thereof obtainable by a method according to the invention.

Various display methods are known in the art, among them, phage display, yeast display, bacterial display and ribosome display are widely used for screening studies (cf. for example Winter et al 1994 Annu Rev Immunol 12:433-455, Feldaus et al 2003 Nat Biotechnol 21:163-170, Hanes J. and Pluckthun A. 1997 PNAS 94:4937-42). Typically, these techniques allow large antibody libraries to be screened against a bait molecule. Alternatively, methods allowing the detection of intracellular interaction have been developed. Within these methods, a bait protein is expressed in the cell. Examples of such methods are the yeast two hybrid method (cf. Fields and Song, 1989 and WO0200729), the cyto Trap method (cf. Broder et al, 1998 and U.S. Pat. No. 5,776,689), the protein fragment complementation (PCA) method (cf. Johnsson and Varshavsky, 1994 and WO9529195) and the intracellular method described in the application filed by MilleGen with application number EP 06290641.

An embodiment of the present invention provides a method for obtaining a library of cells, each comprising a polynucleotide encoding antibodies or fragments thereof, comprising the steps of:

a) obtaining a library of polynucleotides encoding antibodies, derivatives thereof or fragments thereof by the method according to the invention; and
b) transforming cells with the polynucleotides obtained in step a).

An embodiment of the present invention provides a library of cells obtainable by this method.

Typically, the cells comprising a polynucleotide encoding an antibody, a derivative thereof or a fragment thereof, express on their surface the antibody, the derivative thereof or the fragment thereof. Typically, the cells are bacterial cells or yeast cells.

An embodiment of the present invention provides a method for obtaining a library of phages, each comprising a polynucleotide encoding an antibody, a derivative thereof or a fragment thereof and displaying on its surface said antibody, said derivative thereof or said fragment thereof, comprising the step of:

a) obtaining a library of polynucleotides encoding antibodies, derivatives thereof or fragments thereof by a method according to the invention; and
b) generating the phages.

An embodiment of the present invention provides a library of phages obtainable by this method.

An embodiment of the present invention provides a method for producing an antibody, a derivative thereof or a fragment thereof which binds to a bait molecule comprising the steps of:

a) obtaining a library of polynucleotide encoding antibodies, derivatives thereof or fragments thereof obtainable by a method according to the invention; and
b) isolating from the library a polynucleotide which encodes an antibody, a derivative thereof or a fragment thereof which binds to said bait molecule.

In the following, the invention will be illustrated by means of the following examples as well as the figures. In all the figures, the CDRs (usually in bold) and the framework regions (FR) were defined according to structural criteria defined by Chothia et al (1989) Nature 342, 877-883.

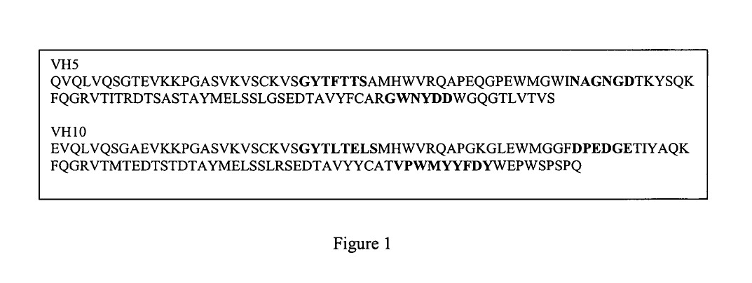

FIG. 1: Amino acids sequences of the variable heavy chain gene VH5 (SEQ ID N^{o}1) and VH10 (SEQ ID N^{o}2).

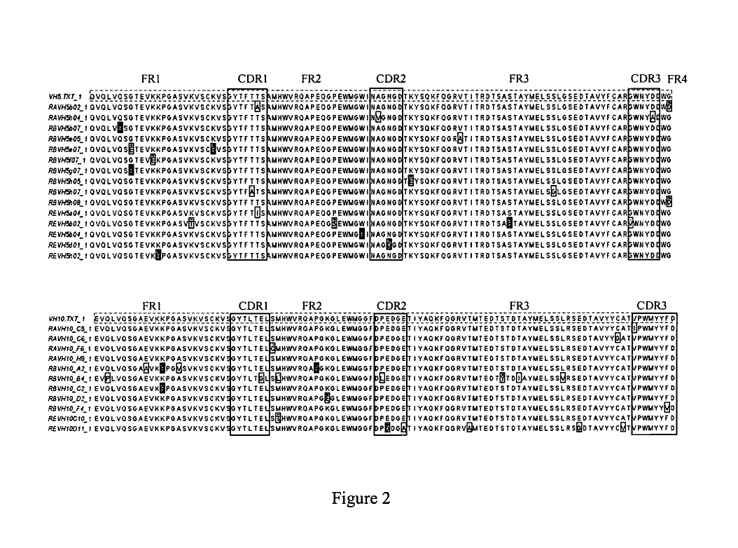

FIG. 2: Mutations of the heavy variable genes VH5 and VH10.

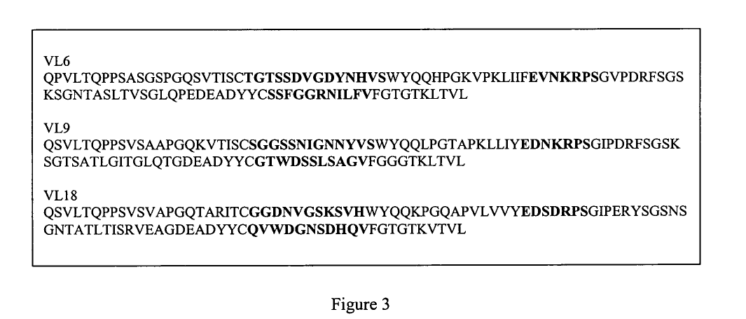

FIG. 3: Amino acids sequences of three variable lambda genes VL6 (SEQ ID N^{o}8), VL9 (SEQ ID N^{o}9) and VL18 (SEQ ID N^{o}10).

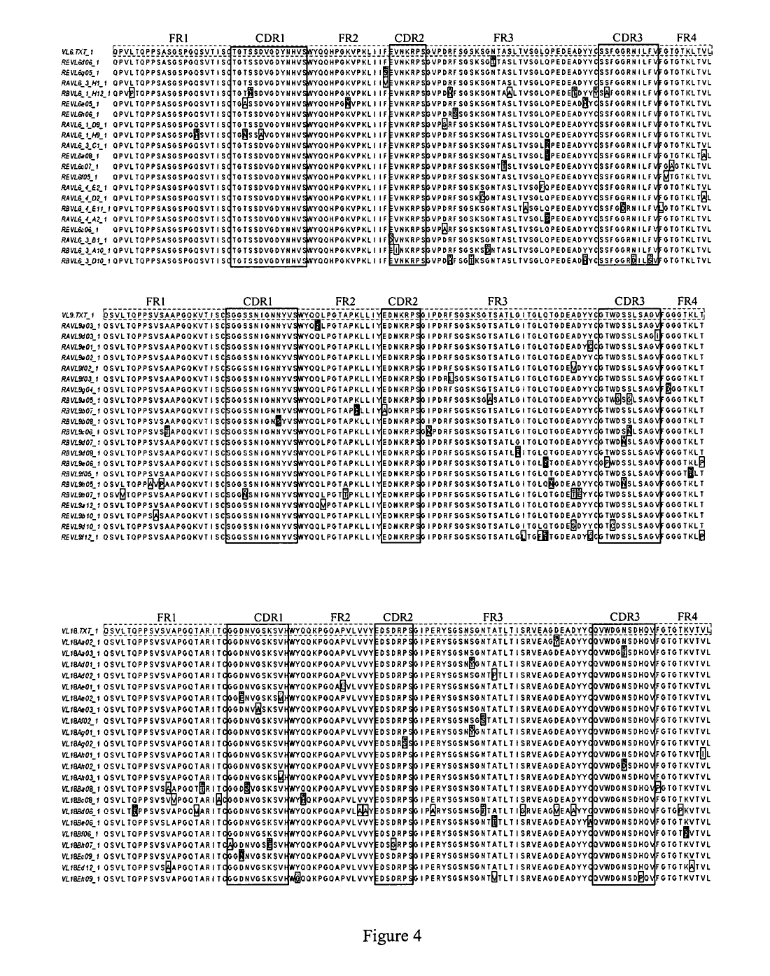

FIG. 4: Mutations of the lambda variable genes VL6, VL9 and VL18.

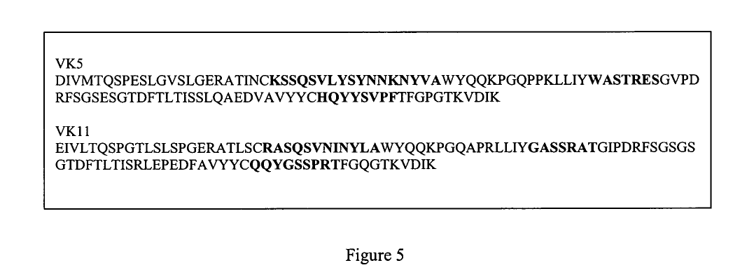

FIG. 5: Amino acids sequences of two variable kappa chain genes, VK5 (SEQ ID N^{o}12) and VK11 (SEQ ID N^{o}13). The CDRs (in bold) were defined according to structural criteria defined by Chothia et al (1989) Nature 342, 877-883.

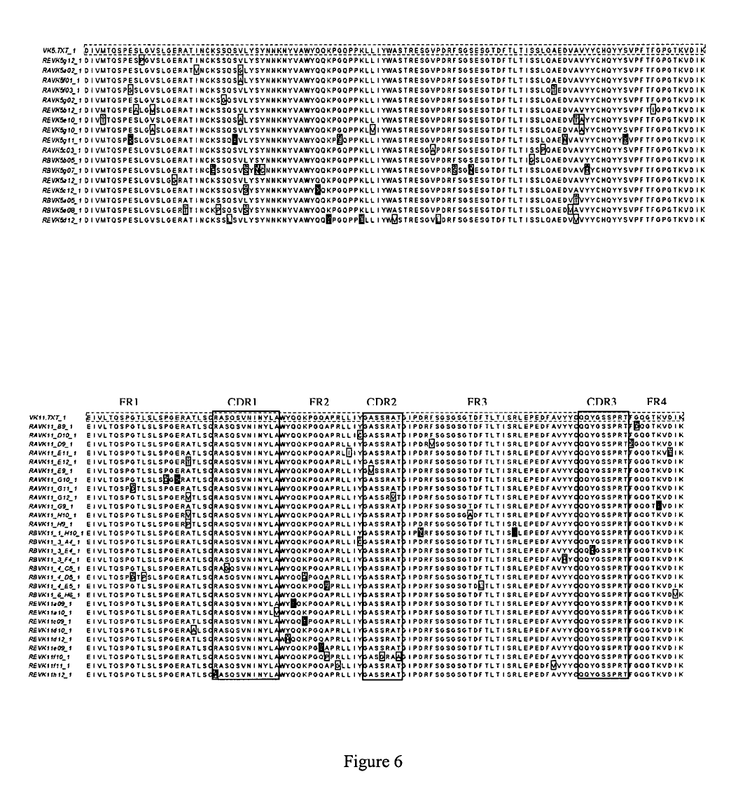

FIG. 6: Mutations of the kappa variable genes VK5 and VK11

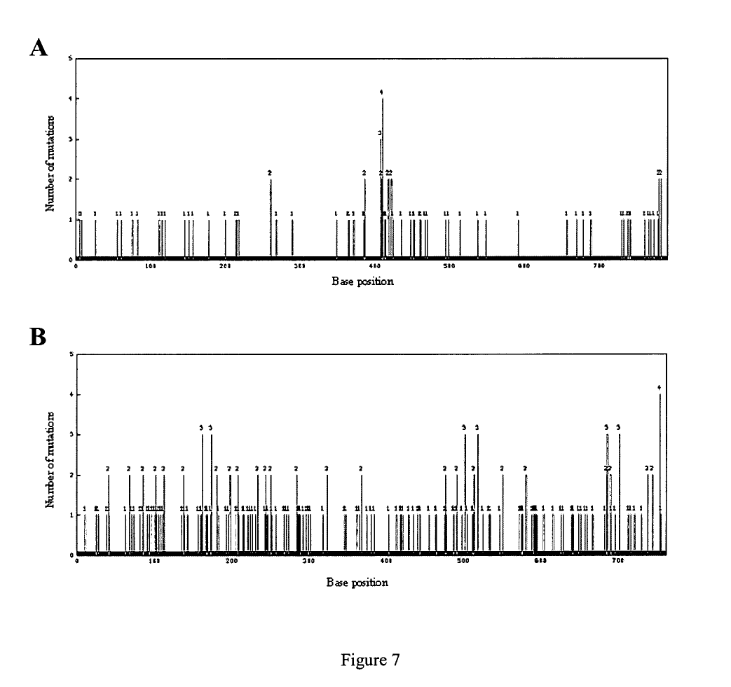

FIG. 7: Representation of the number of mutations along the sequence of single chain antibodies (scFv) of the MB_scFv2e_A_E library (A) and MB_scFv2e_B_N library (B).

### EXAMPLES

In the following description, all molecular biology experiments are performed according to standard protocol (Sambrook J, Fritsch E F and Maniatis T (eds) Molecular cloning, A laboratory Manual 2^{nd} Ed, Cold Spring Harbor Laboratory Press).

### Example 1

### Random Mutagenesis of Isolated Variable Domains of Human Antibodies

### A. Amplification and Cloning of the Human Antibody Repertoires of Variable Heavy and Light Chain Domains.

Total peripheral blood monocyte (PBMC) RNA was isolated from 100 donors. The donors were healthy or were afflicted with diverse diseases: Bacterial or viral infections, autoimmune diseases, endocrine diseases (e.g. diabetes) and cancer. PBMC mRNA was isolated and antibody heavy and light chains (Vlambda and Vkappa) cDNA produced from the reverse transcription were PCR amplified with several mixtures of primer pair characteristics of the N-terminal and C-terminal extremities of all different families of the variable genes.

The VH were PCR amplified using 14 different VH forward primers and a mixture of 4 JH reverse primers. A second PCR with tagged primers were used to introduce restriction sites SalI in 5′ and EcoRI in 3′ of the VH fragments. The VH PCR products were cloned into SalI and EcoRI restriction sites of pUC18 vector.

The Vlambda cDNA were PCR amplified with 15 different Vlambda forward primers and 3 JL reverse primers and the Vkappa cDNA were PCR amplified with a mix of 13 VK forward primers and 5 JK reverse primers. The Vlambda and Vkappa fragments were PCR amplified with tagged primers to introduce XbaI in 5′ and SalI in 3′ and cloned into SalI and XbaI restriction site of pUC18.

Each library HS_VH, HS_Vlambda and HS_Vkappa contained 1-3×10⁶ members:

TABLE 1
Human antibody heavy and light chain libraries cloned

| Library name | HS_VH | HS_Vlambda | HS_Vkappa |
|---|---|---|---|
| Vector | pUC18 | pUC18 | pUC18 |
| Size | 1 × 10⁶ | 3 × 10⁶ | 1.25 × 10⁶ |

B. Mutagenesis of Two Variable Heavy Chain Domains from the Human Antibody Repertoire

The DNA encoding the variable heavy domains of two randomly picked clones, VH5 (SEQ ID N^{o}1) and VH10 (SEQ ID N^{o}2), from the human library repertoire HS_VH were mutated with the MutaGen™ process. The MutaGen™ is described in WO0238756. The DNA coding for the VH5 and VH10 clones corresponded to the germline gene IGHV1-3 and IGHV1-24, respectively. For this determination the blast program was used on the IMGT web site: http://imgt.cines.fr/. The sequences are described in FIG. 1. The mutagenesis process was designed to modify the complete variable gene without the JH region. This region was not mutated in prevision of possible future use as template in an overlap PCR to associate the VH and the VL libraries. Two randomly mutated libraries were constructed MB-VH5 and MB-VH10.

a. Mutagenesis of the VH Domains

The VH genes were double replicated with human polymerase beta using the 5′ primer Mut-PD-S1 5′-CGAGCGTCTACTAGCGCATGCCTGCAGGTCGAC-3′ (SEQ ID N^{o}3), the 3′ primer as an equimolar mixture of 4 primers [JH-1/2-for-mut: 5′-ATGCGTGAATTCTGAGGAGACGGTGACCAGGGTGCC (SEQ ID N^{o}4), JH-3-for-mut: 5′-ATGCGTGAATTCTGAAGAGACGGTGACCATTGTCCC-3′ (SEQ ID N^{o}5), JH-4/5-for-mut: 5′-ATGCGTGAATTCTGAGGAGACGGTGACCAGGGTTCC-3′ (SEQ ID N^{o}6), JH-6-for-mut: 5′-ATGCGTGAATTCTGAGGAGACGGTGACCGTGGTCCC-3′ (SEQ ID N^{o}7)] and 1 μg of plasmid pUC18-VH (pUC18-VH5 or pUC18-VH10) as template in the replication buffer A, B or E (cf. table 2).

TABLE 2
Conditions of replication for the random mutagenesis

| | dATP | dCTP | dTTP | dGTP | Mn²⁺ | DMSO |
|---|---|---|---|---|---|---|
| Condition A | 50 μM | 50 μM | 100 μM | 100 μM | | |
| Condition B | 20 μM | 100 μM | 100 μM | 100 μM | 0.5 mM | |
| Condition C | 20 μM | 100 μM | 100 μM | 100 μM | 0.5 mM | 10% |
| Condition E | 20 μM | 100 μM | 100 μM | 100 μM | 0.25 mM | |
| Condition N | 100 μM | 100 μM | 100 μM | 100 μM | | |

The mixture was denatured for 5 min at 95° C. and cooled down to 4° C. An equal volume of a solution containing 4 units of human polymerase beta in replication buffer A, B or E was added to each replication reaction A, B and E. The reactions of replication were carried out at 37° C. for one hour. The replication products were then purified through phenol-chloroform and ethanol precipitation.

b. Selective Amplification and Cloning of Mutated Fragments

The replication products obtained in replication conditions A, B and E were selectively amplified through a selective PCR amplification with tail primers. The primers were designed with a tail that is non-specific to the template and allowed to specifically amplify the DNA fragments synthesized by the mutases.

A fraction of each replication product obtained in the replication conditions A, B and E was added to a mixture containing the PCR buffer (20 mM Tris HCl pH 8.4, 50 mM KCl) (Life Technologies), 1.5 mM MgCl₂, 10 pmol of the 5′ and 3′ primers, 200 microM of the 4 dNTPs and 1.25 U Platinum Taq DNA polymerase (Life Technologies). This mixture was incubated 5 min at 95° C., 5 sec at 55 C, 30 sec at 72° C. following by 30 selective cycles of 20 sec at 94° C. and 30 sec at 72° C.

The amplified replication products were cloned into SalI and EcoRI restriction sites of pUC18 to obtain MB-VH5 and MB-VH10 libraries.

c. Analyze of Randomly Mutated Libraries of the Selected VH Domains.

A repertoire of randomly mutated VH domains was obtained. Test screening of individual randomly picked library clones by DNA sequencing revealed an intact insert that contained randomly mutated VH5 or VH10 gene (cf. FIG. 2). The mutations are distributed randomly along the entire VH gene (i.e. the framework regions and the CDR loops).

The modifications of the mutated sequences were analyzed with the software Mutanalyse 2.5 (MilleGen). The frequency of mutations (cf. table 3) of the MB-VH5 and MB-VH10 libraries were 5.55 and 9.64 mutation per kilo bases, respectively. The average frequency of mutations of 7.58 per kilobases of the MB-VH5 and MB-VH10 libraries means 2.41 base mutations per gene.

By active part of the library, it is meant the quantity of clones with open reading frames and thus potentially coding for functional variable antibody domains.

TABLE 3
Mutation frequencies of the heavy and light variable genes of the isolated
genes

| | MB- | MB- | MB- | MB- | MB- | MB- | MB- |
|---|---|---|---|---|---|---|---|
| | VH5 | VH10 | VL6 | VL9 | VL18 | VK5 | VK11 |
| Number of replicated bases sequenced per | 319 | 318 | 333 | 324 | 324 | 339 | 318 |
| gene | | | | | | | |
| Number of sequences studied | 28 | 32 | 63 | 61 | 67 | 63 | 64 |
| Active part of the library (%) | 78.5 | 46.8 | 50.7 | 41 | 49.2 | 36.5 | 56.2 |
| Base Mutation frequency (on the active | 5.55 | 9.64 | 8.72 | 8.14 | 8.89 | 8.97 | 5.15 |
| part of the library/kb) | | | | | | | |
| Number of amino acid residues (a.a) | 106 | 106 | 111 | 108 | 108 | 113 | 106 |
| replicated per gene | | | | | | | |
| Number of sequences with a stop | 2 | 1 | 2 | 1 | 1 | 0 | 0 |
| Number of sequences with silence | 4 | 4 | 9 | 3 | 4 | 6 | 7 |
| mutations | | | | | | | |
| Number of sequences studied | 16 | 10 | 21 | 21 | 28 | 17 | 29 |
| Amino acids Mutation frequency (%) | 1.27 | 1.97 | 1.92 | 1.68 | 2.10 | 2.26 | 1.28 |

All different kinds of base mutations are represented (cf. table 4). The different transitions represented 82% (MB-VH5) and 52% (MB-VH10) and the transversions 18% and 48% (cf. table 4). The majority of the clones have 1 base mutation, however, some clones could have up to 11 base mutations (cf. table 5). Because of the silence mutation, this high level of base mutations does not result in a high level of amino acid change. The base mutations could also induce a silence mutation or a stop codon. The amino-acid mutation frequencies of the active part of the library were 1.27% and 1.97% for MB-VH5 and MB-VH10, respectively (cf. table 3). Table 6 shows the frequency of amino acid mutations according to the position in the frameworks and the CDR.

TABLE 4
Mutation diversity

| | MB- | MB- | MB- | MB- | MB- | MB- | MB- |
|---|---|---|---|---|---|---|---|
| | VH5 | VH10 | VL6 | VL9 | VL18 | VK5 | VK11 |
| % A=>G or | 43.58 | 28.26 | 52.22 | 36.36 | 41.86 | 45.71 | 54.23 |
| T=>C | | | | | | | |
| % G=>A or | 38.46 | 23.91 | 23.33 | 30.3 | 24.41 | 34.28 | 32.2 |
| C=>T | | | | | | | |
| % A=>T or T=>A | 2.56 | 0 | 3.33 | 7.57 | 3.48 | 2.85 | 1.69 |
| % A=>C or | 7.69 | 28.26 | 13.33 | 13.63 | 18.6 | 11.42 | 5.08 |
| T=>G | | | | | | | |
| % G=>C or | 2.56 | 8.69 | 1.11 | 7.57 | 5.81 | 1.42 | 3.38 |
| C=>G | | | | | | | |
| % G=>T or | 5.12 | 10.86 | 6.66 | 4.54 | 5.81 | 4.28 | 3.38 |
| C=>A | | | | | | | |

TABLE 5
Base mutation distribution per sequence

| | MB- | MB- | MB- | MB- | MB- | MB- | MB- |
|---|---|---|---|---|---|---|---|
| | VH5 | VH10 | VL6 | VL9 | VL18 | VK5 | VK11 |
| 1 mutation/seq | 11 | 10 | 15 | 13 | 17 | 9 | 23 |
| 2 mutations/seq | 7 | 0 | 6 | 5 | 5 | 5 | 6 |
| 3 mutations/seq | 2 | 1 | 2 | 0 | 3 | 2 | 5 |
| 4 mutations/seq | 2 | 0 | 3 | 1 | 2 | 1 | 1 |
| 5 mutations/seq | 0 | 0 | 0 | 0 | 0 | 2 | 1 |
| 6 mutations/seq | 0 | 1 | 1 | 3 | 3 | 1 | 0 |
| 7 mutations/seq | 0 | 0 | 1 | 2 | 0 | 1 | 0 |
| 8 mutations/seq | 0 | 2 | 1 | 0 | 0 | 0 | 0 |
| 9 mutations/seq | 0 | 0 | 2 | 0 | 0 | 2 | 0 |
| 10 mutations/seq | 0 | 0 | 1 | 1 | 1 | 0 | 0 |
| 11 mutations/seq | 0 | 1 | 0 | 0 | 1 | 0 | 0 |
| 12 mutations/seq | 0 | 0 | 0 | 0 | 1 | 0 | 0 |

TABLE 6
Frequency of amino acid mutations in the different frameworks
(FR) and CDR of the MB-VH5 and MB-VH10

| | FR1 | CDR1 | FR2 | CDR2 | FR3 | CDR3 |
|---|---|---|---|---|---|---|
| Number of | 12 | 4 | 7 | 5 | 11 | 4 |
| Mutation | | | | | | |
| Number of | 25 | 7 | 19 | 6 | 41 | 6-8 |
| residues/genes | | | | | | |
| Total Number | 650 | 182 | 494 | 156 | 1066 | 182 |
| of residues* | | | | | | |
| Frequency of | 1.84 | 2.19 | 1.4 | 3.2 | 1.03 | 2.19 |
| aa mutation | | | | | | |
| (%) | | | | | | |

*number of residues × number of mutated genes studied.
FR: framework of the variable domain,
CDR: Complementary determining region of the variable domain

C. Mutagenesis of Three Variable Lambda (VL) Domains from the Human Antibody Repertoire

The DNA encoding the variable lambda domains of three clones, VL6 (SEQ ID N^{o}8), VL9 (SEQ ID N^{o}9) and VL18 (SEQ ID N^{o}10), picked randomly from the human library repertoire HS_Vlambda were randomly mutated with the MutaGen™ process. The sequences of the clones are described in FIG. 3. The VL6, VL9 and VL18 clones corresponded to the germline gene IGLV2-8, IGLV1-51 and IGLV3-21, respectively. Three highly diversified libraries were constructed MB-VL6, MB-VL9 and MB-VL18.

a. Mutagenesis of the Selected Vlambda Domains

The VL genes were double replicated with human polymerase beta using the 5′ primer Mut-PD-S1 5′-CGAGCGTCTACTAGCGCATGCCTGCAGGTCGAC-3′ (SEQ ID N^{o}3), the 3′ primer VL-K1-R 5′-TCAGTCTATCGTCACGTCAACGGCGGCGGATCTTCTAGA-3′ (SEQ ID N^{o}11) and 1 μg of plasmid pUC18-VL (pUC18-VL6, pUC18-VL9 or pUC18-VL18) as template in the replication buffer A, B or E (cf. table 2). Each mixture was denatured for 5 min at 95° C. and cool down to 4° C. An equal volume of a solution containing 4 units of polymerase beta in replication buffer A, B or E was added. The reactions of replication were carried out at 37° C. for one hour. The replication products were then purified.

b. Selective Amplification and Cloning of Mutated Fragments

The replication products were selectively amplified through a selective PCR amplification with tail primers. The primers were designed with a tail that is not specific to the template and allow specific amplification of DNA fragments synthesized by the mutases.

A fraction of each replication product obtained in the replication conditions A, B and E was added to a mixture containing the PCR buffer (20 mM Tris HCl pH 8.4, 50 mM KCl) (Life Technologies), 1.5 mM MgCl₂, 10 μmol of the 5′ and 3′ primers, 200 microM of the 4 dNTPs and 1.25 U PlatinumTaq DNA polymerase (Life Technologies). This mixture was incubated 5 min at 95° C., 5 sec at 55° C., 30 sec at 72° C. following by 30 selective cycles of 20 sec at 94° C. and 30 sec at 72° C. The amplified replication products were cloned into XbaI and SalI restriction sites of pUC18 to obtain: MB-VL6, MB-VL9 and MB-VL18 libraries.

c. Analysis of Randomly Mutated Libraries of the Selected Vlambda Domains

A repertoire of randomly mutated VL domains was obtained: MB-VL6, MB-VL9 and MB-VL18. Test screening of individual randomly picked library clones by DNA sequencing revealed an intact insert that contained randomly mutated VL6, VL9 or VL18 gene (cf. FIG. 4). The mutations are distributed randomly along the entire VL gene (i.e. the framework regions and the CDR loops). The modifications of the mutated sequences were analyzed with the software Mutanalyse 2.5 (MilleGen).

The frequencies of mutations (cf. table 3) of the MB-VL6, MB-VL9 and MB-VL18 libraries were 8.72, 8.14 and 8.89 mutation per kilo bases, respectively. The average frequency of mutations of 8.58 per kilobases of the three MB-VL libraries means 2.80 base mutations per gene.

All different kinds of base mutations are represented (cf. table 4). The average of the different transitions represented 69% and the transversions 31% (cf. table 4). The majority of the clones have 1 base mutation, however, some clones could have up to 12 base mutations (table 5). Because of the silence mutation, this high level of base mutations does not result in a high level of amino acid change. The base mutations could also induce a silence mutation or a stop codon. The amino-acid mutation frequencies of the active part of the library were 1.92% 1.68% and 2.10% for MB-VL6, MB-VL9 and MB-VL18, respectively (cf. table 3). Table 7 shows a homogenous distribution of the amino acid mutations according to the position in the frameworks and the CDR.

TABLE 7
Frequency of amino acid mutations in the different frameworks
(FR) and CDR of the MB-VL6, MB-VL9 and MB-VL18

| | FR1 | CDR1 | FR2 | CDR2 | FR3 | CDR3 | FR4 |
|---|---|---|---|---|---|---|---|
| Number of Mutations | 14 | 15 | 12 | 5 | 48 | 15 | 14 |
| Number of | 22 | 11-14 | 15 | 7 | 32 | 11 | 8-10 |
| residues/genes | | | | | | | |
| Total number | 1386 | 795 | 945 | 441 | 2016 | 693 | 588 |
| of residues* | | | | | | | |
| Frequency of | 1.01 | 1.89 | 1.26 | 1.13 | 2.38 | 2.16 | 2.38 |
| amino acid mutation (%) | | | | | | | |

*number of residues × number of mutated genes studied.
FR: framework of the variable domain,
CDR: Complementary determining region of the variable domain

D. Mutagenesis of the Variable Kappa (VK) Domains from the Human Antibody Repertoire

The DNA coding the variable kappa domains of two clones, VK5 (SEQ ID N^{o}12) and VK11 (SEQ ID N^{o}13), picked randomly from the human library repertoire HS-Vkappa were randomly mutated with the MutaGen™ process. The sequences of the clones are described in FIG. 5. The VK5 and VK11 clones corresponded with the germline gene IGKV4-1 and IGKV6-57, respectively. Two randomly mutated libraries were constructed MB-VK5 and MB-VK11.

a. Mutagenesis of the Selected VK Domains

The VK genes were double replicated with human polymerase beta using the 5′ primer Mut-PD-S1 (SEQ ID N^{o}3), the 3′ primer VL-K1-R (SEQ ID N^{o}11) and 1 μg of plasmid pUC18-VK (pUC18-VK5 or pUC18-VK11) as template in three different replication buffers A, B or E (cf. table 2). Each mixture was denatured for 5 min. at 95° C. and cooled down to 4° C. An equal volume of a solution containing 4 units of polymerase beta in replication buffer A, B or E was added. The reactions of replication were carried out at 37° C. for one hour. The replication products were then purified.

b. Selective Amplification and Cloning of Mutated Fragments

The replication products were selectively amplified through a selective PCR amplification with tail primers. The primers were designed with a tail that is not specific to the template and allow specific amplification of DNA fragments synthesized by the mutases.

A fraction of each replication product obtained in conditions A, B and E was added to a mixture containing the PCR buffer (20 mM Tris HCl pH 8.4, 50 mM KCl) (Life Technologies), 1.5 mM MgCl₂, 10 pmol of the 5′ and 3′ primers, 200 μM of the 4 dNTPs and 1.25 U Platinum Taq DNA polymerase (Life Technologies). This mixture was incubated 5 min at 95° C., 5 sec at 55° C., 30 sec at 72° C. followed by 30 selective cycles of 20 sec at 94° C. and 30 sec at 72° C.

The amplified replication products were cloned into XbaI and SalI restriction sites of pUC18 to obtain MB-VK5 and MB-VK11 libraries.

c. Analysis of Randomly Mutated Libraries of the Selected VK Domains

A repertoire of randomly mutated VK domains was obtained: MB-VK5 and MB-VK11. Test screening of individual randomly picked library clones by DNA sequencing revealed an intact insert that contained randomly mutated VK5 or VK11 gene (cf. FIG. 6). The mutations are distributed randomly along the entire VK gene, in the frameworks and/or in the CDR loops. The modifications of the mutated sequences were analyzed with the software Mutanalyse 2.5 (MilleGen).

The frequencies of mutations (cf. table 3) of the MB-VK5 and MB-VK11 libraries were 8.97 and 5.15 mutations per kilo bases, respectively. The average frequency of mutations of 7.06 per kilobases of the MB-VK libraries means 2.31 base mutations per gene.

All different kinds of base mutations are represented (cf. table 4). The average of the different transitions represented 83% and the transversions 27% (cf. table 4). The majority of the clones have 1 base mutation, however, some clones could have up to 9 base mutations (cf. table 5). Because of the silence mutation, this high level of base mutations did not result in a high level of amino acid change. The base mutations could also induce a silence mutation or a stop codon. The amino-acid mutation frequencies of the active part of the library were 2.26% and 1.28% for MB-VK5 and MB-VK11, respectively (cf. table 1). Table 8 shows an homogenous distribution of the amino acid mutations according to the position in the frameworks and the CDR.

TABLE 8
Frequency of amino acid mutations in the different frameworks (FR) and
CDR of the MB-VK5 and MB-VK11

| | FR1 | CDR1 | FR2 | CDR2 | FR3 | CDR3 | FR4 |
|---|---|---|---|---|---|---|---|
| Nber of Mutations | 20 | 16 | 16 | 5 | 22 | 3 | 5 |
| Nber of | 23 | 12-17 | 15 | 7 | 32 | 9 | 10 |
| residues/genes | | | | | | | |
| Nber of residues* | 1058 | 637 | 690 | 322 | 1472 | 414 | 460 |
| Frequency of aa | 1.89 | 2.51 | 2.31 | 1.55 | 1.49 | 0.72 | 1.09 |
| mutation % | | | | | | | |

*number of residues × number of mutated genes studied.
FR: framework of the variable domain,
CDR: Complementary determining region of the variable domain

### Example 2

### Random Mutagenesis Applied to Variable Domain Libraries

### A. Random Mutagenesis of the HS-VH Library

The HS-VH library (c.f. table 1) obtained as described before was double replicated with human polymerase beta using the 5′ primer Mut-PD-S1 (SEQ ID N^{o}3), the 3′ primer as an equimolar mixture of 4 primers [JH-1/2-for-mut (SEQ ID N^{o}4), JH-3-for-mut (SEQ ID N^{o}5), JH-4/5-for-mut (SEQ ID N^{o}6), JH-6-for-mut (SEQ ID N^{o}7)] and 1 μg of plasmid pUC18-VH (HS-VH DNA library) as template in the replication buffer A, B or E (cf. table 2). Each mixture was denatured for 5 min at 95° C. and cooled down to 4° C. An equal volume of a solution containing 4 units of polymerase beta in replication buffer A, B or E was added. The reaction of replication was carried out at 37° C. for one hour.

The replication products obtained in condition A, B and E were selectively amplified through a selective PCR amplification with tail primers. The primers were designed with a tail that is not specific to the template and allow specific amplification of DNA fragments synthesized by the polymerase beta. The replication products selectively PCR amplified were cloned into SalI and EcoRI restriction sites of pUC18 to obtain the library MB_HS_VH_AEB01 (cf. table 9).

### B. Random Mutagenesis of the HS-Vlambda Library.

The HS-VL library (cf. table 1) was double replicated with polymerase beta using the 5′ primer Mut-PD-S1 (SEQ ID N^{o}3), the 3′ primer VL-K1-R (SEQ ID N^{o}11) and 1 μg of plasmid pUC18-VL (MB-VL DNA library) as template in the replication buffer A, B or E (cf. table 2). Each mixture was denatured for 5 min at 95° C. and cooled down to 4° C. An equal volume of a solution containing 4 units of polymerase beta in replication buffer A, B or E was added. The reaction of replication was carried out at 37° C. for one hour. The replication products obtained in condition A, B and E were selectively amplified through a selective PCR amplification with tail primers. The primers were designed with a tail that is not specific to the template and allow specific amplification of DNA fragments synthesized by the polymerase beta. The replication products selectively PCR amplified were cloned into SalI and EcoRI restriction site of pUC18 to obtain the library MB_HS_VL_AEB01 (cf. table 9).

### C. Random Mutagenesis of the HS-Vkappa Library.

The HS-Vkappa library (cf. table 1) was double replicated with polymerase beta using the 5′ primer Mut-PD-S1 (SEQ ID N^{o}3), the 3′ primer VL-K1-R (SEQ ID N^{o}11), 1 μg of plasmid pUC18-VK (HS_VK DNA library) as template in the replication buffer A, B or E (cf. table 2). The mixture was denatured for 5 min at 95° C. and cooled down to 4° C. An equal volume of a solution containing 4 units of polymerase beta in replication buffer A, B or E was added. Each reaction of replication was carried out at 37° C. for one hour. The replication products were selectively amplified through a selective PCR amplification with tail primers. The primers were designed with a tail that is non-specific to the template and allowed to specifically amplify the DNA fragments synthesized by the polymerase beta. The replication products selectively PCR amplify were cloned into SalI and EcoRI restriction site of pUC18 to obtain the library MB_HS_VK_AEB01 (cf. table 9).

### D. Analysis of Randomly Mutated Libraries

The random mutagenesis of the human repertoires of HS_VH, HS_VL and HS_VK domains has provided three libraries: MB_HS_VH_AEB01, MB_HS_VK AEB01 and MB_HS_VL_AEB01, with library sizes of 1.17×10⁷, 9.4×10⁶ and 4.8×10⁶ clones, respectively (cf. table 9).

A sample of 400 randomly picked clones from the different libraries were DNA sequenced and analyzed. A representative sample of reference sequences of each subgroup VH, Vlambda and Vkappa from http://imgt.cines.fr/textes/vquest/refseqhb.html#VQUEST were locally downloaded. The sequences from the libraries were compared to the reference sequences with the bioinformatic tools developed by MilleGen.

A sample of 199 clones of the heavy chain library MB_HS_VH_AEB01 showed a distribution of the subtype different to that was reported in the natural representation (cf. Table 10). The VH1 and VH3 are the most represented as in the natural representation of the subtype, however, VH1 is largely more represented with 56.78%.

The 201 sequenced clones of the light chain libraries (MB_HS_VL_AEB01 and MB_HS_VK_AEB01) showed a high representation of the VL1 (66%) and VK1 (70.36%) subtypes.

The difference of the subtype distribution in the MutalBank libraries compared to the reported frequencies showed the originality of the constructed libraries. This difference is probably due to the origins of donors which are donors afflicted with diverse diseases.

TABLE 9
Size of the different libraries

| Library name | MB_HS_VH_AEB01 | MB_HS_VL_AEB01 | MB_HS_VK_AEB01 |
|---|---|---|---|
| Vector | pUC18 | pUC18 | pUC18 |
| Size | 1.17 × 10⁷ | 9.4 × 10⁶ | 4.8 × 10⁶ |

TABLE 10
Representation of the germline families

| | Germline | Nber of clone | | Natural |
|---|---|---|---|---|
| Name of the library | family | sequenced | Representation | representation⁽¹⁾ |
| MB_HS_VH_AEB01 | | 199 | | |
| | IGHV1 | 113 | 56.78% | 19.57% |
| | IGHV2 | 13 | 6.53% | 6.52% |
| | IGHV3 | 37 | 18.59% | 45.65% |
| | IGHV4 | 5 | 2.51% | 21.74% |
| | IGHV5 | 26 | 13.06% | 2.17% |
| | IGHV6 | 4 | 2.01% | 2.17% |
| | IGHV7 | 1 | 0.50% | 2.17% |
| MB_HS_VL_AEB01 | | 50 | | |
| | IGLV1 | 33 | 66.0% | 17.24% |
| | IGLV2 | 3 | 6.0% | 17.24% |
| | IGLV3 | 2 | 4.0% | 27.59% |
| | IGLV4 | 3 | 6.0% | 10.34% |
| | IGLV5 | 4 | 8.0% | 6.90% |
| | IGLV6 | 0 | 0.0% | 3.45% |
| | IGLV7 | 3 | 6.0% | 6.90% |
| | IGLV8 | 0 | 0.0% | 3.45% |
| | IGLV9 | 1 | 2.0% | 3.45% |
| | IGLV10 | 1 | 2.0% | 3.45% |
| | IGLV11 | 0 | 0.0% | 0.00% |
| MB_HS_VK_AEB01 | | 151 | | |
| | IGKV1 | 107 | 70.86% | 50.00% |
| | IGKV2 | 6 | 3.97% | 26.47% |
| | IGKV3 | 13 | 8.60% | 17.65% |
| | IGKV4 | 19 | 12.58% | 2.94% |
| | IGKV5 | 4 | 2.64% | 2.94% |
| | IGKV6 | 2 | 1.32% | 0.00% |
| | IGKV7 | 0 | 0% | 0.00% |

⁽¹⁾IMGT htt://imgt.cnusc.fr:8104

### Example 3

### Random Mutagenesis Applied to scFv Libraries

The retrotranscript of the variable heavy and light genes of the mouse hybridoma VEBA76.50 were PCR amplified and cloned. The DNA coding for the VH and VL domains corresponded with the germline gene IGHV5Si4 and IGKV1-117 (IMGT web site: http://imgt.cines.fr/). A single chain antibody Fv fragment (scFv) having the structure VH-VK was cloned into the vector pCR4-topoTA to obtain the clone MG_scFv2e.

The MG_scFv2e gene was double replicated with human polymerases beta or eta using the 5′ primer VH-scFv2e-S3 5′-TGACGAGTACTAGCTGCTACACCAGGATCCGAAGTGAAGTT-3′ (SEQ ID N^{o}14) and the 3′ primer VK-scFv2e-R3 5′-ACAGCTACGTGATACGACTCACAGAATTCCCGTTTGATTTCCA-3′ (SEQ ID N^{o}15) and 1 μg MG_scFv2e plasmid DNA as template in the replication buffer E or N (cf. table 2). The mixture was denatured for 5 min at 95° C. and cool down to 4° C. An equal volume of a solution containing 4 units of human polymerase beta (mutase A) or human polymerase eta (mutase B) was added in replication buffer E or N. The reaction of replication was carried out at 37° C. for two hours. The replication products selectively PCR amplified were cloned into BamHI and EcoRI restriction sites of the vector p03.

Two libraries were constructed: MB_scFv2e_A_E obtained from the replication with mutase A in the condition E and MB_scFv2e_B_N from the replication with mutase B in the condition N. The library sizes were 6×10⁵ and 5×10⁵ clones, respectively. The alignment of 31 and 30 sequences obtained from different clones of MB_scFv2e_A_E and MB_scFv2e_B_N libraries shows an homogenous distribution of the base mutations along the DNA sequences (cf. FIG. 7). Table 11 shows the modifications of the mutated sequences analyzed with Mutanalyse 2.5 (MilleGen). According to the mutation conditions used, the libraries obtained have a different mutation profile. The frequency of base mutations is double in the MB_scFv2e_B_N library (7.51 per kb) compared to MB_scFv2e_A_E (3.14 per kb). Furthermore, the mutase B in condition N seems to induce a higher modification of the amino acids. The amino acid mutation frequency was 4 times higher in the MB_scFv2e_B_N library than in MB_scFv2e_A_E library (cf. table 11). The two different mutagenesis conditions lead to a library with a low mutagenesis frequency (0.57 mutation per 100 amino acids) and to library with a high mutagenesis frequency (1.52 mutation per 100 amino acids).

The different transitions represented 80% and the transversions 20% with the two libraries (cf. table 12).

The number of mutations per sequence of the MB_scFv2e_B_N library is widely represented with 59% of the sequences which have between 6 and 12 base modifications (cf. table 13). In contrast, the MB_scFv2e_A_E library has 74% of the sequences with 1-3 base mutations.

TABLE 11
Mutation frequencies of MB_scFv2e_A_E and MB_scFv2e_B_N libraries

| | MB_scFv2e_A_E | MB_scFv2e_B_N |
|---|---|---|
| Nber of replicated bases sequenced | 786 | 759 |
| per gene | | |
| Nber of sequence studied | 31 | 30 |
| Active part of the library (%) | 48 | 47 |
| Base Mutation frequency of the active | 3.14 | 7.51 |
| part of the library (/kb) | | |
| Nber of aa replicated per gene | 262 | 253 |
| Nber of sequence with a stop | 0 | 1 |
| Nber of sequence with silence | 4 | 2 |
| mutations | | |
| Nber of mutated sequence with a total | 15 | 14 |
| open reading frame | | |
| Amino acids Mutation frequency (%) | 0.57 | 1.52 |
| Library size (total number of clones) | 6 × 10⁵ | 5 × 10⁵ |

TABLE 12
Mutation diversity of MB_scFv2e_A_E
and MB_scFv2e_B_N libraries

| | MB_scFv2e_A_E | MB_scFv2e_B_N |
|---|---|---|
| % de A=>G or T=>C | 57.89 | 62.88 |
| % de G=>A or C=>T | 23.68 | 17.52 |
| % de A=>T or T=>A | 0 | 11.34 |
| % de A=>C or T=>G | 10.52 | 6.18 |
| % de G=>C or C=>G | 5.26 | 2.06 |
| % de G=>T or C=>A | 2.63 | 0 |

TABLE 13
Base mutation distribution per sequence of
MB_scFv2e_A_E and MB_scFv2e_B_N libraries

| | MB_scFv2e_A_E | MB_scFv2e_B_N |
|---|---|---|
| 1 mutation/seq | 11 | 5 |
| 2 mutations/seq | 1 | 0 |
| 3 mutations/seq | 2 | 1 |
| 4 mutations/seq | 2 | 0 |
| 5 mutations/seq | 1 | 1 |
| 6 mutations/seq | 0 | 3 |
| 7 mutations/seq | 1 | 1 |
| 8 mutations/seq | 1 | 2 |
| 9 mutations/seq | 0 | 1 |
| 10 mutations/seq | 0 | 0 |
| 11 mutations/seq | 0 | 2 |
| 12 mutations/seq | 0 | 1 |

### REFERENCES

Throughout this application, various references describe the state of the art to which this invention pertains. The disclosures of these references are hereby incorporated by reference into the present disclosure.

1. An in vitro method for obtaining a library of polynucleotides encoding antibodies, derivatives thereof or fragments thereof, comprising the step of performing random mutagenesis of a polynucleotide encoding the variable region of a heavy chain and/or the variable region of a light chain, wherein random mutagenesis is performed on a library of polynucleotides comprising a sequence encoding the variable region of a heavy chain and/or the variable region of a light chain; and
wherein the random mutagenesis process creates randomly distributed mutations along at least 70% of the sequence encoding the variable region.

2. The method according to claim 1, wherein the random mutagenesis process creates randomly distributed mutations along at least 90% of the sequence encoding the variable region.

3. The method according to claim 1, wherein the random mutagenesis process creates randomly distributed mutations along the whole sequence encoding the variable region.

4. The method according to claim 1, comprising the step of performing random mutagenesis of a polynucleotide encoding the variable region of a heavy chain and the step of performing random mutagenesis of a polynucleotide encoding the variable region of a light chain.

5. The method according to claim 1, wherein the polynucleotide encoding the variable region is a polynucleotide encoding a single chain antibody.

6. The method according to claim 1, wherein the library of polynucleotides comprising a sequence encoding the variable region of a heavy chain and/or the variable region of a light chain, is obtainable from B cells isolated from donors selected from the group consisting of healthy donors and donors afflicted with a disease.

7. The method according to claim 1, wherein random mutagenesis is performed by using one or more mutases selected from the group consisting of DNA polymerases beta, iota, eta and kappa.

8. The method according to claim 1, wherein the sequence encoding the variable region of a heavy chain and/or the variable region of a light chain is from human origin.

9. The method according to claim 1, wherein the library of polynucleotides encoding antibodies, derivatives thereof or fragments thereof is a library of polynucleotides encoding derivatives or fragments selected from the group consisting of the variable region of a heavy chain, the variable region of a light chain, Fv, a single chain antibody, Fab, Fab′ and F(ab′)₂.

10. The method according to claim 1, wherein the polynucleotides encoding antibodies, derivatives thereof or fragments thereof are expression vectors.

11. A method for obtaining a library of cells, each comprising a polynucleotide encoding antibodies or fragments thereof, comprising the steps of:
a) obtaining a library of polynucleotides encoding antibodies, derivatives thereof or fragments thereof by the method according to claim 1; and
b) transforming cells with the polynucleotides obtained in step a).

12. The method according to claim 11 wherein the cells comprising a polynucleotide encoding an antibody, a derivative thereof or a fragment thereof, express on their surface the antibody, the derivative thereof or the fragment thereof.

13. The method according to claim 11, wherein the cells are bacterial cells or yeast cells.

14. A method for obtaining a library of phages, each comprising a polynucleotide encoding an antibody, a derivative thereof or a fragment thereof and displaying on its surface said antibody, said derivative thereof or said fragment thereof, comprising the step of:
a) obtaining a library of polynucleotides encoding antibodies, derivatives thereof or fragments thereof by the method according to claim 1; and
b) generating the phages.

15. A library of polynucleotide encoding antibodies, derivatives thereof or fragments thereof obtainable by the method according to claim 1.

16. A library of cells obtainable by the method according to claim 11.

17. A library of phages obtainable by the method according to claim 14.

18. A method for producing an antibody, a derivative thereof or a fragment thereof which binds to a bait molecule comprising the steps of:
a) obtaining a library of polynucleotide encoding antibodies, derivatives thereof or fragments thereof obtainable by the method according to claim 1; and
b) isolating from the library a polynucleotide which encodes an antibody, a derivative thereof or a fragment thereof which binds to said bait molecule.


SEQUENCE LISTING (15 sequences)

SEQ ID NO: 1 - protein, 114 aa, human
QVQLVQSGTEVKKPGASVKVSCKVSGYTFTTSAMHWVRQAPEQGPEWMGWINAGNGDTKYSQKFQGRVTITRDTSASTAYMELSSLGSEDTAVYFCARGWNYDDWGQGTLVTVS

SEQ ID NO: 2 - protein, 116 aa, human
EVQLVQSGAEVKKPGASVKVSCKVSGYTLTELSMHWVRQAPGKGLEWMGGFDPEDGETIYAQKFQGRVTMTEDTSTDTAYMELSSLRSEDTAVYYCATVPWMYYFDYWEPWSPSPQ

SEQ ID NO: 3 - DNA, 33 bp, Artificial sequence
  synthetic primer
cgagcgtctactagcgcatgcctgcaggtcgac

SEQ ID NO: 4 - DNA, 36 bp, Artificial sequence
  synthetic primer
atgcgtgaattctgaggagacggtgaccagggtgcc

SEQ ID NO: 5 - DNA, 36 bp, Artificial sequence
  synthetic primer
atgcgtgaattctgaagagacggtgaccattgtccc

SEQ ID NO: 6 - DNA, 36 bp, Artificial sequence
  synthetic primer
atgcgtgaattctgaggagacggtgaccagggttcc

SEQ ID NO: 7 - DNA, 36 bp, Artificial sequence
  synthetic primer
atgcgtgaattctgaggagacggtgaccgtggtccc

SEQ ID NO: 8 - protein, 111 aa, human
QPVLTQPPSASGSPGQSVTISCTGTSSDVGDYNHVSWYQQHPGKVPKLIIFEVNKRPSGVPDRFSGSKSGNTASLTVSGLQPEDEADYYCSSFGGRNILFVFGTGTKLTVL

SEQ ID NO: 9 - protein, 110 aa, human
QSVLTQPPSVSAAPGQKVTISCSGGSSNIGNNYVSWYQQLPGTAPKLLIYEDNKRPSGIPDRFSGSKSGTSATLGITGLQTGDEADYYCGTWDSSLSAGVFGGGTKLTVL

SEQ ID NO: 10 - protein, 108 aa, human
QSVLTQPPSVSVAPGQTARITCGGDNVGSKSVHWYQQKPGQAPVLVVYEDSDRPSGIPERYSGSNSGNTATLTISRVEAGDEADYYCQVWDGNSDHQVFGTGTKVTVL

SEQ ID NO: 11 - DNA, 39 bp, Artificial sequence
  synthetic primer
tcagtctatcgtcacgtcaacggcggcggatcttctaga

SEQ ID NO: 12 - protein, 113 aa, human
DIVMTQSPESLGVSLGERATINCKSSQSVLYSYNNKNYVAWYQQKPGQPPKLLIYWASTRESGVPDRFSGSESGTDFTLTISSLQAEDVAVYYCHQYYSVPFTFGPGTKVDIK

SEQ ID NO: 13 - protein, 108 aa, human
EIVLTQSPGTLSLSPGERATLSCRASQSVNINYLAWYQQKPGQAPRLLIYGASSRATGIPDRFSGSGSGTDFTLTISRLEPEDFAVYYCQQYGSSPRTFGQGTKVDIK

SEQ ID NO: 14 - DNA, 41 bp, Artificial sequence
  synthetic primer
tgacgagtactagctgctacaccaggatccgaagtgaagtt

SEQ ID NO: 15 - DNA, 43 bp, Artificial sequence
  synthetic primer
acagctacgtgatacgactcacagaattcccgtttgatttcca